(19) United States
(12) Patent Application Publication
(10) Pub. No.: US 2002/0184173 A1
(43) Pub. Date: Dec. 5, 2002

(54) Analog detection, equalization and decoding method and apparatus

(76) Inventor: Jan C. Olivier, Highland Village, TX (US)

Correspondence Address: STEVEN A. SHAW, NOKIA, INC., 6000 CONNECTION DRIVE, MD 1-4-755, IRVING, TX, 75039, US

(21) Appl. No.: 09/834,407

(22) Filed: Apr. 14, 2001

(51) Int. Cl. G06G 7/00

(52) U.S. Cl. 706/26

(57) ABSTRACT

A system and method is provided for performing Turbo Equalization upon a communication system, comprising the usage of nonlinear analog circuitry such as Cellular Nonlinear/neural Networks to overcome the computational burden of traditional DSP technology. Thereby, through operation of various embodiments of the present invention Turbo Equalization may be performed in a more efficient manner.

### CROSS-REFERENCE TO RELATED APPLICATIONS

### BACKGROUND

The present invention relates generally to communications systems. More specifically this invention relates to Turbo Equalization.

A typical communication system may be comprised of a sending station and a receiving station interconnected by a communication channel, (such as a radio-link for example). Data to be communicated by the sending station to the receiving station may be converted, if necessary, into a form to permit its communication upon the communication channel. A communication system may be defined by almost any combination of sending and receiving stations, including, for instance, circuit board-positioned elements as well as more conventionally-defined communication systems used by spaced-apart users to communicate data therebetween.

When data communicated upon a communication channel is received at the receiving station, the receiving station may act upon, if necessary, the received data to recreate the informational content thereof. In an ideal communication system, the data, when received at the receiving station, may be identical to the data when transmitted by the sending station. However, in an actual communication system, the data may be distorted during its communication upon the communication channel. Such distortion may distort values of the data when received at the receiving station. If the distortion is significant, the informational content of the data, as transmitted, may not be recovered.

All communications circuits contain some noise. This is true whether the signals are analog or digital, and regardless of the type of information conveyed. Noise is the eternal bane of communications engineers, who are always striving to find new ways to improve the signal to noise ratio (S/N) in communications systems. Traditional methods of optimizing S/N ratio include, inter alia, increasing the transmitted signal power and increasing the receiver sensitivity. In wireless systems, specialized antenna systems may also help. Digital signal processing (DSP) dramatically improves the sensitivity of a receiving unit. The effect is most noticeable when noise competes with a desired signal. Despite the dramatic improvements provided by a DSP circuit, there are limits to what it can do. If the noise is so strong that all traces of the signal are obliterated, a DSP circuit may not find any order in the chaos, and no signal will be received.

The receiver comprises, inter alia, an equalization unit and a decoder unit. Equalization is the process of maintaining the system transfer function characteristics within specified limits by modifying circuit parameters. Equalization includes modification of circuit parameters, such as resistance, inductance, or capacitance.

These form the bulk of the computational load in the receiver DSP. Digital signal processing (DSP) refers to various techniques for improving the accuracy and reliability of digital communications. The theory behind DSP is quite complex. Basically, DSP works by clarifying, or standardizing, the levels or states of a digital signal. A DSP circuit may be able to differentiate between wanted signals which provide information and noise.

If an incoming signal is analog, for example a standard television broadcast station, the signal is first converted to digital form by an analog-to-digital converter (ADC). The resulting digital signal has two or more levels. Ideally, these levels are always predictable, i.e. exact voltages or currents. However, because the incoming signal contains noise, the levels are not always at the standard values. The DSP circuit adjusts the levels so they are at the correct values. This practically eliminates the noise. The digital signal is then converted back to analog form via a digital-to-analog converter (DAC).

If a received signal is digital, for example computer data, then the ADC and DAC are not necessary. The DSP acts directly on the incoming signal, eliminating irregularities caused by noise, and thereby minimizing the number of errors per unit time.

Currently, an emerging technique called turbo equalization feeds soft information back between these two units by iteration. It has been shown that this technique significantly increases receiver sensitivity.

The discovery of turbo codes has been an important breakthrough in improving performance of many communication systems. Turbo codes effectively achieve random coding and thereby allow reliable communication at data rates near capacity in many channels, yet they posses enough structure to enable practical encoding and decoding. One significant characteristic of turbo codes is the interleaver gain, which is substantially different from the traditional coding approach of improving distance properties. This appears to make turbo coding applicable to a broad class of communication channels with different signal and noise/interference characteristics.

Impressive coding gains and simulation performances of turbo codes on various channels, including the magnetic recording channel, have been demonstrated by several researchers. However, there still exist some serious obstacles, such as high complexity and large memory requirements for the decoding operation.

The CNN Technology (Cellular Nonlinear/neural Network) is based on a new computing paradigm and architecture: the CNN Universal Machine. Its elementary instruction is defined on an array computer where each processor is a dynamical system with continuous signals and containing some additional logic. This unconventional architecture is very close to the anatomy and physiology of many parts of the brain, hence, it is called neuromorphic. In the CNN, each of the processors placed on a two or three-dimensional grid are dynamic cells, and they are interacting mainly with their local neighbor cells/processors. Unlike the cellular automaton or systolic array, here the signals and the time are continuous. The CNN paradigm was invented by Professor Leon Chua of University of California's Department of Electrical Engineering and Computer Sciences (Berkeley; Calif.).

By extending the CNN cell by analog and logic memory as well as additional interface units, and if a special Global Analogic Program Unit (GAPU) drives the whole array, all the key elements of the CNN Universal Machine (CNN-UM) architecture are present.

Since the invention of the CNN-UM (Roska-Chua, 1992), several VLSI chips were designed and recent experiments show close to trillion operations per second computing power on 1 cm² silicon area.

It has been shown that turbo equalization significantly increases receiver sensitivity. However, in spite of the potential gain in performance, the computational burden for Turbo Equalization is high so that implementation in software receivers has been difficult.

In Germany, Joachin Hagenauer has proposed a new kind of implementation technology for equalizers, decoders and also Turbo Equalizers. In his paper, “Analog Turbo Networks in VLSI: The next step in turbo decoding and Equalization” (referencing a German patent application No 19725275.3 filed on Jun. 14, 1997), some non-linear property of the transistor is used to conform to the probability of distribution of the maximum likelihood problem. It is also shown that the statistical nature of the problem he is trying to solve is the same as the transfer function of the transistor. However, in practical applications such as mobile stations for example, the Hagenauer solution would force the usage of multiple chips in order to support different modulations.

The above-mentioned references are exemplary only and are not meant to be limiting in respect to the resources and/or technologies available to those skilled in the art.

### SUMMARY

An embodiment of the present invention defines a method for performing turbo equalization in real time using an analog circuit comprising a CNN decoder and a CNN equalizer. A method is comprised of minimizing a maximum likelihood metric and satisfying a constraint function while admitting discrete solutions.

An apparatus for performing turbo equalization in real time using an analog circuit is also provided as an embodiment of the present invention. The circuit has CNN hardware wherein a maximum likelihood metric and a constraint function admitting discrete solutions are implemented.

The present invention, accordingly, advantageously provides a method, and an associated apparatus, by which to effectuate a great number of iterations in the turbo equalizer.

Operation of embodiments of the present invention provides that the equalizer and the decoder being constructed by analog hardware will be able to supply symbol and bit estimates in a few nanoseconds frame time.

In the present invention cellular technology is used as the preferred embodiment, providing a series of advantages that will become apparent to the person skilled in the art.

In case of a phone supporting different modulations the Hagenauer solution would force the usage of multiple chips. It is one object of the present invention to remove such a limitation.

Another advantage of the present invention in relation to the cited related art is that channel estimation may be implemented in order to perform the detection successfully. This enables embodiments of the present invention to cope with rapidly changing and time varying communications channels.

These and other features, aspects, and advantages of embodiments of the present invention will become apparent with reference to the following description in conjunction with the accompanying drawings. It is to be understood, however, that the drawings are designed solely for the purposes of illustration and not as a definition of the limits of the invention, for which reference should be made to the appended claims.

### BRIEF DESCRIPTION OF THE DRAWINGS

FIG. 1 is a block diagram illustrative of a canonical detection circuit with symbol feedback.

FIG. 2 is a diagram illustrative of a turbo equalizer where the CNN equalizer and CNN decoder are implemented in analog hardware and share mutual soft informations.

FIG. 3 is a diagram illustrative of the Chua non-linear programming circuit in accordance with an embodiment of the present invention.

FIG. 4 is a diagram illustrative of a convolutional encoder in accordance with an embodiment of the present invention.

### DETAILED DESCRIPTION

In the description of the preferred embodiment, the data source will be considered as a large set of binary numbers, possibly encoded by a channel encoder. In one embodiment of the present invention, we will not be concerned with the nature of the source data, but only with its detection in the receiver after passing through the dispersive and noisy time varying channel. Moreover, operation of an embodiment of the present invention provides that the source data may be transmitted in discrete bursts, containing data as well as known training and pilot symbols. The symbols are complex numbers representing the source data according to the specific modulation technique employed. The carrier may then modulated according to the burst symbols by the modulator.

In the continuous time domain, a model for the received signal in baseband is given by:

$$y ( t ) = {\sum }_{m = 0}^{M} {d}_{m} h ( t - m T ) + n ( t ) \qquad ( 1 )$$

The noise n(t) is assumed to be a complex random process, and the data sequence dₘ is a discrete complex symbol set to be estimated. The dispersive nature of the channel is modeled by the convolution with the Impulse Response h(t) including all the combined effects of the channel, transmission and anti-alias receive filters. Operation of an embodiment of the present invention provides that the channel is assumed to be essentially time invariant over the duration of the burst. Hence, h(t) will be constant during a particular burst but time variant with the arrival of new bursts.

The discrete time equivalent channel, obtained by sampling the received signal y(t) at a fixed rate n/T, yields sufficient statistics to enable data estimation in one embodiment of the present invention.

The constant T will be referred to as the symbol period. Using matrix notation (upper case matrices and lower case vectors) the discrete time channel can be written as:

y=Hd+nₛ (2)

The channel impulse response matrix H is fundamental to the equalization and detection problem, and has special properties. It has a form given by:

$$\begin{matrix}h [ 0 ] & 0 & 0 & 0 & 0 & 0 & 0 & 0 \\ h [ 1 ] & h [ 0 ] & 0 & 0 & 0 & 0 & 0 & 0 \\ h [ 2 ] & h [ 1 ] & h [ 0 ] & 0 & 0 & 0 & 0 & 0 \\ h [ 3 ] & h [ 2 ] & h [ 1 ] & h [ 0 ] & 0 & 0 & 0 & 0 \\ h [ M ] & … & & h [ 1 ] & h [ 0 ] & 0 & 0 & 0 \\ … & … & & & & h [ 0 ] & 0 & 0 \\ 0 & 0 & h [ M ] & & & h [ 1 ] & h [ 0 ] & 0 \\ 0 & 0 & … & h [ M ] & & … & h [ 1 ] & h [ 0 ]\end{matrix} \qquad ( 3 )$$

Operation of an embodiment of the present invention provides that a sequence d, such that the sequence error (Maximum Likelihood Sequence Estimation) is minimized, should be chosen:

εₛₑ²=∥y−Hd∥² (4)

The person skilled in the art will recognize that the expression in (4) is not minimum phase. A procedure for transforming it to the minimum phase form is provided in the following.

The essential idea is to minimize ε² (MLSE) given by:

ε²=∥Ly−Ud∥² (5)

U might be upper or lower triangular, diagonally dominant, and minimum phase.

In one embodiment of the present invention, the canonical detection system as shown in FIG. 1 may be used to derive the optimal forms for the matrices L and U as they act as filters, that is to say solving equation (1).

Matrices L and U have to be designed so that the SNR of the signal presented to the decision device in FIG. 1 is maximized.

The detection circuit represented is used to implement the model for the received signal in baseband described in (1) is so defined:

in block 11 matrix L is implemented,

in block 12 a decision apparatus on symbol n is represented

in block 13 the matrix 1-U is implemented.

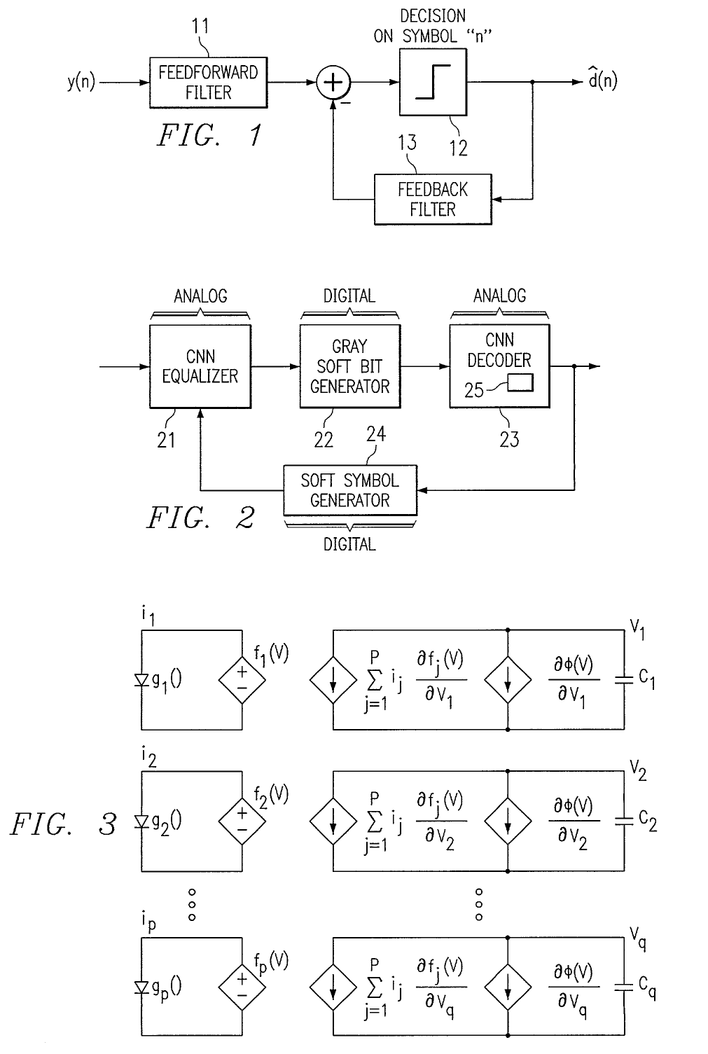

Turning now to FIG. 2, which is illustrative of a turbo equalizer wherein the CNN equalizer and CNN decoder are implemented in analog hardware and share mutual soft information via digital control circuitry.

After the process of error decoding has been performed, the input to the equalizer can be easily reconstructed since the encoding and interleaver/deinterleaver processes are very economical digital processes.

Thus, the analog equalization process can be performed again on data which are less prone to contain errors. Then, since the equalization was performed on improved data, the equalizer output is less likely to contains errors, thus enabling the decoder to produce even better bit estimates, and so the process of turbo equalization continues.

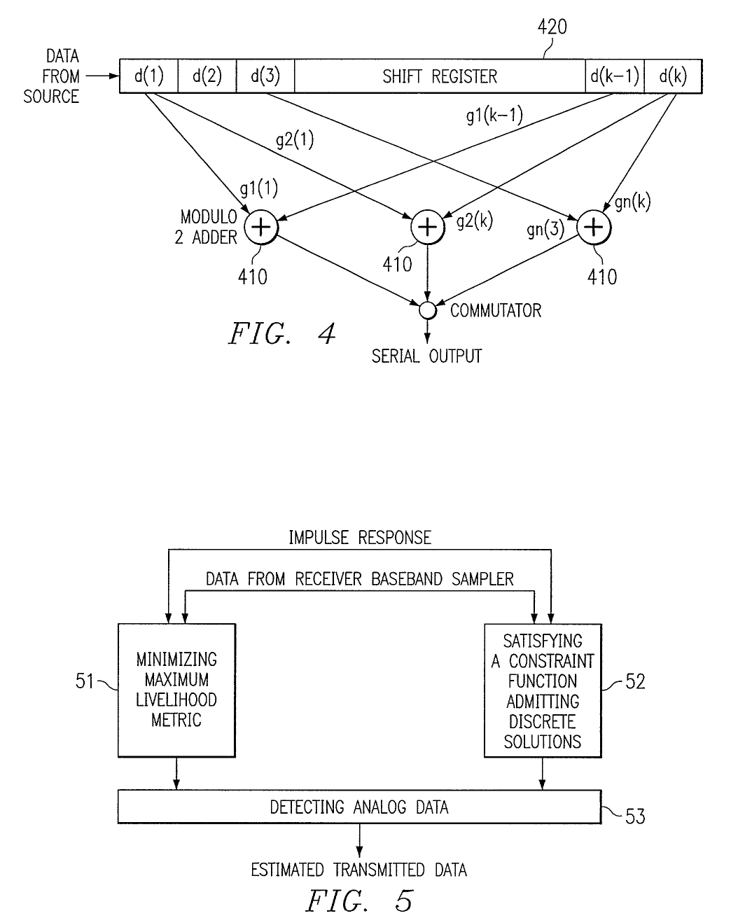

Referring now to FIG. 3, operation of an embodiment of the present invention provides that both the equalizer and the error decoder may be realized using the analog Chua nonlinear network hardware.

A solution is given by a sequence d minimizing a suitable cost function subject to the constraint that the data being estimated are part of a discrete set. Thus, it is an object of the present invention to minimize a maximum likelihood metric that in one embodiment of the present invention would be in the form:

φ²=ε²=∥Ly−Ud∥² (6)

subject to a constraint that the elements of d are part of a set D containing all the symbols used in the transmitter modulator The maximum likelihood metric may minimize the symbol probability of error, if the noise statistics are Gaussian. If not Gaussian, it will minimize the least square noise energy.

Such a constraint in accordance with one embodiment of the present invention would be in the form:

$$f ( {d}_{q} ) = A - {\prod }_{j = 1}^{M} {‖ {d}_{q} - D ( j ) ‖}^{2} \geq 0 \qquad ( 7 )$$

where A is a non-zero constant, and M the size of the modulation constellation set D. Expression (7) for the constraint on the q^{th} element of d is a constraint function admitting discrete solutions that are part of the modulation constellation.

The optimization problem as given above constitutes a nonlinear programming problem and is well suited to a solution by the Chua CNN. As shown in (5), the Chua circuit shown in FIG. 3 may solve the nonlinear programming problem given by:

MIN(φ(ν₁,ν₂,ν₃,ν₄ . . . ν_{Q})) (8)

subject to

$$\begin{matrix}{f}_{1} ( {υ}_{1} , {υ}_{2} , {υ}_{3} , {υ}_{4} … {υ}_{Q} ) \geq 0 \\ {f}_{2} ( {υ}_{1} , {υ}_{2} , {υ}_{3} , {υ}_{4} … {υ}_{Q} ) \geq 0 \\ … \\ {f}_{1} ( {υ}_{1} , {υ}_{2} , {υ}_{3} , {υ}_{4} … {υ}_{Q} ) \geq 0\end{matrix} \qquad ( 9 )$$

The nonlinear programming problem (8) and (9) has to have the following properties:

At least one (or more) solution exists;

Φ and f are continuous; and

both first and second order partial derivative exist.

Clearly, these are satisfied by (6) and (7).

The form of the nonlinear programming problem (8) and (9) is identical to what we require for solving (6) subject to (7).

With this correspondence, it is postulated that,

νᵢ≡dᵢ (10)

νᵢ being the node voltage in the Chua circuit, corresponding to (i.e. representing) the transmitted symbols d_{q} we wish to estimate.

iⱼ=g(fⱼ(V)), where g( ) is a non-linear function, approximating the transfer function of the diode with finite slope.

Hence the parameters of the Chua circuit can be calculated directly from the minimum phase IR matrix U, the transformed vector Ly and the modulation constellation D for each slot.

The circuit is turned on with random voltages and is allowed to settle into a state of equilibrium.

In M. P. Kennedy and L. O. Chua, “Neural Networks for Nonlinear Programming”, IEEE Trans. Circuits and Systems., Vol. 35, No. 5, pp. 554-562, (May 1988), it is shown that a Chua circuit is unconditionally stable, so it will settle after a time determined by the circuit time constant.

Since there are no resistors in the circuit, the circuits time constant is only limited by conductor losses, which are very small. Convergence thus will follow in a few nanoseconds with the current VLSI technology.

The circuit node voltages (i.e. dm) change in time in such a way that ε² is minimized, subject to them taking on only values that are elements of the modulation constellation D.

Since the circuit settling time is typically many orders of magnitude smaller than the burst duration, it is possible to apply the circuit many times with different random starting points, and the best solution obtained in terms of the smallest ε² can be used as an estimate of d.

FIG. 3 is diagram illustrative of the Chua nonlinear programming circuit which is used in the preferred embodiment of the present invention to obtain V₁, V₂, . . . V_{q}. which are representative of d₁, d₂, . . . d_{q} by inputting functions fⱼ and Φ in the j circuit.

The Error Correction Decoding (ECD) problem is an optimization problem and can be solved in the same way as the equalization problem.

We can model the encoder operating on an analog signal as for the equalization problem, since we will demand the discrete nature of the estimated data via a constraint function. Hence, we replace the modulo 2 adders in FIG. 4 with a nonlinear function given at time n.

$$p [ n ] = {sin}^{2} ( \frac{π}{2} ⟨ g , d ⟩ ) \qquad ( 11 )$$

Where <g3,0d> represents the inner product between the bits in the shift register and the generator vector for a particular output node.

Thus, the output of the encoder for a vector d(i)=[dᵢ,dᵢ₋₁, . . . ,dᵢ₋₍ₖ₋₁₎] in the shift register becomes

$${E}_{out} [ {sin}^{2} ( \frac{π}{2} ⟨ {g}_{1} , d ( i ) ⟩ ) … , {sin}^{2} ( \frac{π}{2} ⟨ {g}_{n} , d ( i ) ⟩ ) ] \qquad ( 12 )$$

where the encoder is rate 1/n and G denotes the n generator vectors in matrix format.

A sequence of real numbers may be formed as a function of time that is the output of the encoder, given an input sequence d denoted by Eₒᵤₜ(G,d).

Operation of an embodiment of the present invention provides that the optimum decoder would adhere to the following rules:

For a memoryless additive white gaussian noise channel, over a finite set of soft received bits from the equalizer, denoted by E_{equ}, with energy normalized to unity, data sequence d may be chosen such that the following expression is minimized:

φ²=ε²=∥E_{equ}−(2Eₒᵤₜ(G,d)−1∥² (13)

A memoryless channel means that the bits coming into the decoder are not correlated except for the contribution from the encoder. The channel does not introduce correlation between bits, it only adds noise.

The elements of d must be part of a discrete set C, typically {0,1}.

Such a constraint in a particular embodiment of the present invention is represented by:

$$f ( {d}_{q} ) = A - {\prod }_{j = 1}^{2} {‖ {d}_{q - Cj )} ‖}^{2} \geq 0 \qquad ( 14 )$$

Having defined the cost function and the constraint on d as it has been done for the equalization problem, the CNN analog circuit may be applied equivalently also to the Error Decoding problem in the same advantageous way.

FIG. 4 a diagram illustrative of a convolutional encoder in accordance with an embodiment of the present invention used to solve equations (13) and (14). The case of convolutional encoding in FIG. 4 is used as an example only. Those skilled in the art after reading the specification including the case may arrive at variations or modifications, such as using the claimed embodiments in block coding as well. Said variations and modification are deemed to be within the scope and spirit of the invention.

The convolutional encoder is part of block 23 of FIG. 2.

The present invention, accordingly, advantageously provides a method, and an associated apparatus, by which to better effectuate Turbo Equalization.

Referring again to FIG. 2, in one embodiment of the improved Turbo Equalizer made possible by the present invention, block 21 represents the equalization apparatus where the problem of minimization of (6) subject to constrain (7) is solved.

Block 22 represents a soft bit generator, which operates a conversion of symbol to bits for the input of equation (13). Block 23 represents the detection apparatus where the problem of minimization of (13) subject to constrain (14) is solved. Block 24 represents a soft bit generator, which operates a conversion of bits to symbol for the input of equation (6), which is the fundamental idea of turbo equalization.

While, in the exemplary implementation, the apparatus of an embodiment of the present invention is shown constructed pursuant and citing the EDGE standard, operation of an embodiment of the present invention can also analogously be implemented in other communication systems, wireless and fixed, in which communication is effectuated.

Equivalently, CNN equalizer and decoder have been shown as the preferred embodiment of the invention.

Any analog circuit satisfying equations within the scope of (6) and (7) or (13) and (14) would work as well and must be considered within the spirit and scope of the present invention.

In the present invention, the equalizer and decoder is not implemented in software on a DSP chip as is usually done, but the implementation is in analog hardware. The analog nature of the implementation removes the issue of complexity and the Turbo Equalization method may easily be performed in this way.

The equalizer and error correcting decoder use an analog search/optimization procedure implemented in Cellular Non-linear Networks (CNN).

Although described in the context of particular embodiments, it will be apparent to those skilled in the art that a number of modifications and various changes to these teachings may occur. Thus, while the invention has been particularly shown and described with respect to one or more preferred embodiments thereof, it will be understood by those skilled in the art that certain modifications or changes, in form and shape, may be made therein without departing from the scope and spirit of the invention as set forth above and claimed hereafter.

What is claimed is:

1. A method for performing turbo equalization in real time using an analog circuit comprising a CNN decoder and a CNN equalizer, the method comprising the steps of:
minimizing a maximum likelihood metric; and
satisfying a constraint function admitting discrete solutions only.

2. The method of claim 1 wherein said discrete solutions will contain only symbol alphabet points.

3. The method of claim 1 wherein the step of mimizing said maximum likelyhood metric is applied to said CNN equalizer.

4. The method of claim 1 wherein the step of mimizing said maximum likelihood metric is applied to said CNN decoder.

5. The method of claim 1 further comprising the step of feeding back a solution from said CNN decoder to said CNN equalizer.

6. The method of claim 5 wherein the steps of
minimizing said maximum likelyhood metric and satisfying said constraint function are iteratively performed through said feeding back step.

7. The method of claim 1 wherein said constraint function comprises computing finite number of difference terms.

8. The method of claim 7 wherein said difference terms comprise a candidate solution of said maximum likelyhood metric and a symbol alphabet point.

9. The method of claim 8 wherin said constraint function comprises a constant.

10. The method of claim 9 wherein the usage of said constant forces said candidate solution to a symbol alphabet point.

11. An apparatus for performing turbo equalization in real time using an analog circuit comprising:
CNN hardware wherein a maximum likelyhood metric and a constraint function admitting discrete solutions only are implemented.

12. The appratus of claim 11 wherein said discrete solutions will only contain symbol alphabet points.

13. The apparatus of claim 11 wherein said CNN hardware is part of an equalizer apparatus.

14. The apparatus of claim 13 wherein said equalizer apparatus is implemented in a transceiver.

15. The apparatus of claim 11 wherein said CNN hardware is part of a decoder apparatus.

16. The apparatus of claim 15 wherein said decoder apparatus is implemented in a transceiver.

17. A method for performing real time turbo equalization comprising the steps of:
using a non-linear network; and
embedding in said non-linear network a constraint function which will admit discrete solutions only.

18. A method for performing turbo equalization in real time using analog circuitry comprising the steps of:
minimizing a maximum likelyhood metric; and
satisfying a constraint function admitting discrete solutions only.
